(19) United States
(12) Patent Application Publication
(10) Pub. No.: US 2020/0190273 A1
(43) Pub. Date: Jun. 18, 2020

(54) METHOD FOR PRODUCING A COMPOSITE MATERIAL

(71) Applicant: ROQUETTE FRERES, Lestrem (FR)

(72) Inventors: Hélène AMEDRO, BETHUNE (FR); Jean-Marc CORPART, LAMBERSART (FR); Nicolas JACQUEL, LAMBERSART (FR); René SAINT-LOUP, LOMME (FR)

(21) Appl. No.: 16/608,963

(22) PCT Filed: May 7, 2018
(86) PCT No.: PCT/EP2018/061725

§ 371 Date: Oct. 28, 2019

(30) Foreign Application Priority Data
May 5, 2017 (FR) 1754008

(51) Int. Cl. C08J 5/04; C08G 63/672

(52) U.S. Cl. CPC C08J 5/045; C08J 2367/02; C08G 63/672

(57) ABSTRACT

A process for producing a composite material, said process comprising the following steps of a) providing a polymer, b) providing natural fibers, c) preparing a composite material from said fibers and said thermoplastic polymer, said process being characterized in that the polymer is a thermoplastic polyester comprising at least one 1,4: 3,6-dianhydrohexitol unit (A), at least one alicyclic diol unit (B) other than the 1,4: 3,6-dianhydrohexitol units (A), at least one terephthalic acid unit (C), wherein the (A)/[(A)+(B)] ratio is at least 0.05 and at most 0.75, said polyester not containing any aliphatic non-cyclic diol units or comprising a molar amount of aliphatic non-cyclic diol units, relative to all the monomer units of the polyester, of less than 5%, and the reduced viscosity in solution (25° C.; phenol (50% m): ortho-dichlorobenzene (50% m); 5 g/l of polyester) of which is greater than 50 ml/g.

### FIELD OF THE INVENTION

The present invention relates to the field of materials and relates to a process for producing a composite material based on natural fibers and at least one thermoplastic polyester having at least one 1,4: 3,6-dianhydrohexitol unit, which may have excellent impact strength properties.

### TECHNOLOGICAL BACKGROUND

Because of their mechanical properties, plastic materials and especially thermoplastic materials are widely used in industry for the manufacture of a multitude of products. Thus, manufacturers are constantly looking for new compounds, such as thermoplastic polymers, having improved properties or new processes which make it possible to improve the properties of existing polymers.

To this end, in order to increase the mechanical strength of polymers, it is known to incorporate various compounds therein in order to create composite materials having improved mechanical properties. These various compounds to a certain extent serve as reinforcement, substantially improving the mechanical behavior of the polymers within which they are incorporated.

In recent years, the market for composite materials has seen continual growth. Thus, numerous sectors of activity integrate these new materials in the design of their products, for instance medical, sports, automotive, or else green energy. Composite materials constitute new sources of innovation and offer new growth opportunities for industry.

Composite materials, defined as materials consisting of a reinforcement and a matrix, are distinguished from other synthetic plastic products by characteristics that allow them, with properties of inalterability and low weight, to be able in some cases to replace metal parts.

For many years, manufacturers around the world have been carrying out research aiming to incorporate materials of natural origin into plastics. This research is a response to the desire to preserve the environment while limiting the removal of non-renewable materials. Natural fibers incorporated in thermoplastic materials as a replacement for glass fibers form composites that are already being manufactured and sold on the market.

Thus, natural fibers are known to be good reinforcements in materials, and in particular in thermoplastic polymers in order to obtain composites.

At present, these composites based on natural fibers, also referred to as biocomposites, are found in a multitude of everyday products such as automobile interior trim parts, building materials or even sports articles.

Innovation on these biocomposites has been developing strongly over the last few years and relates not only to the use of fibers as reinforcement, but also the development of increasingly bio-based thermoplastic polymer resins and the interactions between these natural fibers and the matrices.

One of the difficulties in the production of composite materials is creating good adhesion of the fiber to the polymer matrix. This is because cellulose, the main component of plant fiber, is relatively incompatible with conventional thermoplastic matrices.

The hydrophilic nature of the plant fibers is the source of the lack of compatibility with the more hydrophobic matrix. Very few bonds exist between the “reinforcement” phase and the “matrix” phase. This “incompatibility” causes poor dispersion of the fibers in the matrix and the formation of a heterogeneous material. The hydroxyl functions of the cellulose form hydrogen bonds between the cellulose chains, causing the aggregation of the fibers with one another and the formation of a composite in which the fibers are poorly dispersed.

Another limitation to the use of natural fibers in composites is their ability to retain water. The water binds by intra- and inter-bonds with the hydroxyl groups of the cellulose. Thus, the water contained in the mixtures can then adversely affect, or even make impossible, the forming of the material. This is because the low hydrophilicity of the resins customarily used in the production of thermoplastic composites makes the fiber/polymer interface highly unstable, thus damaging the mechanical properties of the composite obtained.

In order to overcome these disadvantages, one of the solutions may consist in introducing a third element compatible with the fibers and the matrix and which acts as a link. Other solutions exist, for instance carrying out a thermomechanical treatment of the fibers that cause surface fibrillation, leading to anchoring of the fiber in the matrix or else thoroughly drying the fibers before incorporation. Thus, the vast majority of processes for producing composite materials based on polymer matrix and plant fibers implement a drying step. However, this drying step consumes a lot of energy, thus entailing significant operating costs during the implementation of the processes for producing the composites. In addition, this step is also harmful in that it greatly reduces the elasticity of the fibers due to the evaporation of the water initially present therein, thus rendering the composite obtained much less efficient with regard to impact strength properties.

In light of the industrial demand for efficient plastic materials with improved properties, there is a continuous need to have processes that make it possible to obtain them and in particular make it possible to obtain stronger thermoplastic polymers with improved mechanical properties, said processes being easier to implement and especially cheaper.

It is thus to the applicant's credit to have found that this objective could be achieved with the production process according to the invention.

### SUMMARY OF THE INVENTION

A first subject of the invention relates to a process for producing a composite material, said process comprising the following steps of:
a) providing a thermoplastic polymer,
b) providing natural fibers,
c) preparing a composite material from said natural fibers and said thermoplastic polymer, said process being characterized in that the polymer is a thermoplastic polyester comprising at least one 1,4: 3,6-dianhydrohexitol unit (A), at least one alicyclic diol unit (B) other than the 1,4: 3,6-dianhydrohexitol units (A), at least one terephthalic acid unit (C), wherein the (A)/[(A)+(B)] ratio is at least 0.05 and at most 0.75, said polyester not containing any aliphatic non-cyclic diol units or comprising a molar amount of aliphatic non-cyclic diol units, relative to all the monomer units of the polyester, of less than 5%, and the reduced viscosity in solution (25° C.; phenol (50% m): ortho-dichlorobenzene (50% m); 5 g/l of polyester) of which is greater than 50 ml/g;

A second subject of the invention relates to a composite material produced based on natural fibers and thermoplastic polyester as defined previously. Due to its mechanical properties, this material is most particularly applicable for the manufacture of automobile parts, for use as a construction material or else for the manufacture of sports or leisure articles.

### DETAILED DESCRIPTION OF THE INVENTION

A first subject of the invention therefore relates to a process for producing a composite material, said process comprising the following steps of:
a) providing a polymer,
b) providing natural fibers,
c) preparing a composite material from said natural fibers and said thermoplastic polymer,
   said process being characterized in that the polymer is a thermoplastic polyester comprising at least one 1,4: 3,6-dianhydrohexitol unit (A), at least one alicyclic diol unit (B) other than the 1,4: 3,6-dianhydrohexitol units (A), at least one terephthalic acid unit (C), wherein the (A)/[(A)+(B)] ratio is at least 0.05 and at most 0.75, said polyester not containing any aliphatic non-cyclic diol units or comprising a molar amount of aliphatic non-cyclic diol units, relative to all the monomer units of the polyester, of less than 5%, and the reduced viscosity in solution (25° C.; phenol (50% m): ortho-dichlorobenzene (50% m); 5 g/l of polyester) of which is greater than 50 ml/g. Entirely surprisingly, by virtue of the thermoplastic polyester used, the production process according to the invention does not necessarily require drying of the natural fibers prior to the preparation of the composite material. Indeed, those in the art hitherto believed that drying prior to the preparation of the composite material to obtain an efficient material, which is in particular not subject to the problems of poor interfacial cohesion between the fibers and the matrix observed in known composite materials employing undried natural fibers in the prior art was a prerequisite. The process according to the invention thus has the advantage of being able to be implemented with or without drying of the natural fibers prior to the preparation of the composite material, and of obtaining good cohesion at the fiber/matrix interface.

According to a preferred embodiment, the natural fibers are not dried prior to the preparation of the composite material, thus providing improved impact strength compared to composites for which the fibers are dried beforehand.

For the purposes of the present invention, the terms “composite material” or “biocomposite” are considered to be synonymous. A biocomposite is a composite material that is partially or wholly derived from biomass, such as starch or cellulose, for example, the bio-based nature being able to originate from the reinforcement and/or the matrix.

The first step of the process consists in providing a polymer. The polymer used according to the process of the invention is a thermoplastic polymer as defined previously, and therefore constitutes the matrix of the composite material.

The thermoplastic polyester does not contain any aliphatic non-cyclic diol units or comprises a molar amount of aliphatic non-cyclic diol units.

“Small molar amount of aliphatic non-cyclic diol units” is intended to mean, especially, a molar amount of aliphatic non-cyclic diol units of less than 5%. According to the invention, this molar amount represents the ratio of the sum of the aliphatic non-cyclic diol units, these units possibly being identical or different, relative to all the monomer units of the polyester.

Advantageously, the molar amount of aliphatic non-cyclic diol unit is less than 1%. Preferably, the polyester does not contain any aliphatic non-cyclic diol units and more preferentially it does not contain any ethylene glycol.

An aliphatic non-cyclic diol may be a linear or branched aliphatic non-cyclic diol. It may also be a saturated or unsaturated aliphatic non-cyclic diol. Aside from ethylene glycol, the saturated linear aliphatic non-cyclic diol may for example be 1,3-propanediol, 1,4-butanediol, 1,5-pentanediol, 1,6-hexanediol, 1,8-octanediol and/or 1,10-decanediol. As examples of saturated branched aliphatic non-cyclic diol, mention may be made of 2-methyl-1,3-propanediol, 2,2,4-trimethyl-1,3-pentanediol, 2-ethyl-2-butyl-1,3-propanediol, propylene glycol and/or neopentyl glycol. As an example of an unsaturated aliphatic diol, mention may be made, for example, of cis-2-butene-1,4-diol.

Despite the low amount of aliphatic non-cyclic diol, and hence of ethylene glycol, used for the synthesis, a thermoplastic polyester is obtained which has a high reduced viscosity in solution and in which the isosorbide is particularly well incorporated.

The monomer (A) is a 1,4: 3,6-dianhydrohexitol and may be isosorbide, isomannide, isoidide, or a mixture thereof. Preferably, the 1,4:3,6-dianhydrohexitol (A) is isosorbide.

Isosorbide, isomannide and isoidide may be obtained, respectively, by dehydration of sorbitol, of mannitol and of iditol. As regards isosorbide, it is sold by the applicant under the brand name Polysorb® P.

The alicyclic diol (B) is also referred to as aliphatic and cyclic diol. It is a diol which may especially be chosen from 1,4-cyclohexanedimethanol, 1,2-cyclohexanedimethanol, 1,3-cyclohexanedimethanol or a mixture of these diols. The alicyclic diol (B) is very preferentially 1,4-cyclohexanedimethanol. The alicyclic diol (B) may be in the cis configuration, in the trans configuration, or may be a mixture of diols in the cis and trans configurations.

The molar ratio of 1,4:3,6-dianhydrohexitol units (A)/sum of 1,4:3,6-dianhydrohexitol units (A) and alicyclic diol units (B) other than the 1,4: 3,6-dianhydrohexitol units (A), i.e. (A)/[(A)+(B)], is at least 0.05 and at most 0.75. When the (A)/[(A)+(B)] molar ratio is less than 0.30, the thermoplastic polyester is semicrystalline and is characterized by the presence of a crystalline phase which results in the presence of X-ray diffraction lines and the presence of an endothermic melting peak in differential scanning calorimetry (DSC) analysis.

On the other hand, when the (A)/[(A)+(B)] molar ratio is greater than 0.30, the thermoplastic polyester is amorphous and is characterized by an absence of X-ray diffraction lines and by an absence of an endothermic melting peak in differential scanning calorimetry (DSC) analysis.

A thermoplastic polyester that is particularly suitable for the production process according to the invention comprises:
a molar amount of 1,4: 3,6-dianhydrohexitol units (A) ranging from 2.5 to 54 mol %;
a molar amount of alicyclic diol units (B) other than the 1,4: 3,6-dianhydrohexitol units (A) ranging from 5 to 42.5 mol %;
a molar amount of terephthalic acid units (C) ranging from 45 to 55 mol %.

Depending on the desired properties and applications, those skilled in the art can adapt the amounts to obtain an amorphous or semicrystalline thermoplastic polyester.

For example, if, for some applications, it is sought to obtain a composite material that can be opaque and that has improved mechanical properties, the thermoplastic polyester may be semicrystalline and thus comprises:
a molar amount of 1,4: 3,6-dianhydrohexitol units (A) ranging from 2.5 to 14 mol %;
a molar amount of alicyclic diol units (B) other than the 1,4: 3,6-dianhydrohexitol units (A) ranging from 31 to 42.5 mol %;
a molar amount of terephthalic acid units (C) ranging from 45 to 55 mol %.

Advantageously, when the thermoplastic polyester is semicrystalline, it has an (A)/[(A)+(B)] molar ratio of 0.10 to 0.25.

Conversely, when it is desired for the composite material to be transparent, the thermoplastic polyester may be amorphous and thus comprises:
a molar amount of 1,4: 3,6-dianhydrohexitol units (A) ranging from 16 to 54 mol %;
a molar amount of alicyclic diol units (B) other than the 1,4: 3,6-dianhydrohexitol units (A) ranging from 5 to 30 mol %;
a molar amount of terephthalic acid units (C) ranging from 45 to 55 mol %.

Advantageously, when the thermoplastic polyester is amorphous, it has an (A)/[(A)+(B)] molar ratio of 0.35 to 0.65.

Furthermore, those skilled in the art can readily find the analysis conditions for determining the amounts of each of the units of the thermoplastic polyester. For example, from an NMR spectrum of a poly(1,4-cyclohexanedimethylene-co-isosorbide terephthalate), the chemical shifts relating to the 1,4-cyclohexanedimethanol are between 0.9 and 2.4 ppm and 4.0 and 4.5 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

The thermoplastic polyesters have a glass transition temperature ranging from 85 to 200° C., for example from 90 to 115° C. if they are semicrystalline, and for example from 116° C. to 200° C. if they are amorphous. The glass transition temperatures and melting points are measured by conventional methods, especially using differential scanning calorimetry (DSC) using a heating rate of 10° C./min. The experimental protocol is described in detail in the examples section below.

The thermoplastic polyesters of the composite material according to the invention, when they are semicrystalline, have a melting point ranging from 210 to 295° C., for example from 240 to 285° C.

Advantageously, when the thermoplastic polyester is semicrystalline, it has a heat of fusion of greater than 10 J/g, preferably greater than 20 J/g, the measurement of this heat of fusion consisting in subjecting a sample of this polyester to a heat treatment at 170° C. for 16 hours, then in evaluating the heat of fusion by DSC by heating the sample at 10° C./min.

The thermoplastic polyester of the composite material according to the invention in particular has a lightness L* greater than 40. Advantageously, the lightness L* is greater than 55, preferably greater than 60, most preferentially greater than 65, for example greater than 70. The parameter L* may be determined using a spectrophotometer, via the CIE Lab model.

Finally, the reduced viscosity in solution of the thermoplastic polyester used in step a) of the process of the invention is greater than 50 ml/g and preferably less than 150 ml/g, this viscosity being able to be measured using an Ubbelohde capillary viscometer at 25° C. in an equi-mass mixture of phenol and ortho-dichlorobenzene after dissolving the polymer at 130° C. with stirring, the concentration of polymer introduced being 5 g/I. This test for measuring reduced viscosity in solution is, due to the choice of solvents and the concentration of the polymers used, perfectly suited to determining the viscosity of the viscous polymer prepared according to the process described below.

The semicrystalline or amorphous nature of the thermoplastic polyesters is characterized, after a heat treatment of 16 h at 170° C., by the presence or absence of X-ray diffraction lines or of an endothermic melting peak in differential scanning calorimetry (DSC) analysis. Thus, when X-ray diffraction lines are present and an endothermic melting peak is present in differential scanning calorimetry (DSC) analysis, the thermoplastic polyester is semicrystalline, and if they are absent, it is amorphous.

According to a particular embodiment, the thermoplastic polyester according to the invention may contain one or more additives, said additives being added to the thermoplastic polyester during the manufacture of the composite material in order to give it particular properties.

Thus, by way of examples of additives, mention may be made of nanometric or non-nanometric, functionalized or non-functionalized fillers or fibers of organic or mineral nature. They may be silicas, zeolites, glass beads or fibers, clays, mica, titanates, silicates, graphite, calcium carbonate, carbon nanotubes, wood fibers, carbon fibers, polymer fibers, proteins, cellulose-based fibers, lignocellulosic fibers and non-destructured granular starch. These fillers or fibers can make it possible to improve the hardness, the rigidity or the surface appearance of the parts printed.

The additive may also be chosen from opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The additive may also be a UV-resistance agent such as, for example, molecules of benzophenone or benzotriazole type, such as the Tinuvin™ range from BASF: tinuvin 326, tinuvin P or tinuvin 234, for example, or hindered amines such as the Chimassorb™ range from BASF: Chimassorb 2020, Chimassorb 81 or Chimassorb 944, for example.

The additive may also be a fire-proofing agent or flame retardant, such as, for example, halogenated derivatives or non-halogenated flame retardants (for example phosphorus-based derivatives such as Exolit® OP) or such as the range of melamine cyanurates (for example Melapur™: melapur 200), or else aluminum or magnesium hydroxides.

Finally, the additive may also be an antistatic agent or else an anti-block agent, such as derivatives of hydrophobic molecules, for example Incroslip™ or Incromol™ from Croda.

According to one particular embodiment, the thermoplastic polyester used in the process of the invention represents from 25 to 75% by weight relative to the total weight of the composite material, preferentially from 40 to 60% by weight relative to the total weight of the composite material.

The thermoplastic polyester implemented in the process for producing the composite material according to the invention may especially be prepared according to the process described in application FR1554597. More particularly, it is prepared according to the preparation process comprising:
a step of introducing, into a reactor, monomers comprising at least one 1,4: 3,6-dianhydrohexitol (A), at least one alicyclic diol (B) other than the 1,4: 3,6-dianhydrohexitols (A) and at least one terephthalic acid (C), the molar ratio ((A)+(B))/(C) ranging from 1.05 to 1.5, said monomers not containing any aliphatic non-cyclic diols or comprising, relative to all of the monomers introduced, a molar amount of aliphatic non-cyclic diol units of less than 5%;
a step of introducing a catalytic system into the reactor;
a step of polymerizing said monomers to form the polyester, said step consisting of:
   a first stage of oligomerization, during which the reaction medium is stirred under an inert atmosphere at a temperature ranging from 265 to 280° C., advantageously from 270 to 280° C., for example 275° C.;
   a second stage of condensation of the oligomers, during which the oligomers formed are stirred under vacuum, at a temperature ranging from 278 to 300° C. so as to form the polyester, advantageously from 280 to 290° C., for example 285° C.;

a step of recovering the thermoplastic polyester.

This first stage of the process is carried out in an inert atmosphere, that is to say under an atmosphere of at least one inert gas. This inert gas may especially be dinitrogen. This first stage may be carried out under a gas stream and it may also be carried out under pressure, for example at a pressure of between 1.05 and 8 bar.

Preferably, the pressure ranges from 3 to 8 bar, most preferentially from 5 to 7.5 bar, for example 6.6 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example once the monomers have been introduced into the reactor, by creating a vacuum then by introducing an inert gas such as nitrogen thereto. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the polyester obtained at the end of the process.

The second stage of condensation of the oligomers is carried out under vacuum. The pressure may decrease continuously during this second stage by using pressure decrease gradients, in steps, or else using a combination of pressure decrease gradients and steps. Preferably, at the end of this second stage, the pressure is less than 10 mbar, most preferentially less than 1 mbar.

The first stage of the polymerization step preferably has a duration ranging from 20 minutes to 5 hours. Advantageously, the second stage has a duration ranging from 30 minutes to 6 hours, the beginning of this stage consisting in the moment at which the reactor is placed under vacuum, that is to say at a pressure of less than 1 bar.

The process also comprises a step of introducing a catalytic system into the reactor. This step may take place beforehand or during the polymerization step described above.

Catalytic system is intended to mean a catalyst or a mixture of catalysts, optionally dispersed or fixed on an inert support.

The catalyst is used in amounts suitable for obtaining a thermoplastic polyester used in step a) of the process according to the invention.

An esterification catalyst is advantageously used during the oligomerization stage. This esterification catalyst can be chosen from derivatives of tin, titanium, zirconium, hafnium, zinc, manganese, calcium and strontium, organic catalysts such as para-toluenesulfonic acid (PTSA) or methanesulfonic acid (MSA), or a mixture of these catalysts. By way of example of such compounds, mention may be made of those given in application US 2011282020A1 in paragraphs [0026] to [0029], and on page 5 of application WO 2013/062408 A1.

Preferably, a zinc derivative or a manganese, tin or germanium derivative is used during the first stage of transesterification.

By way of example of amounts by weight, use may be made of from 10 to 500 ppm of metal contained in the catalytic system during the oligomerization stage, relative to the amount of monomers introduced.

At the end of transesterification, the catalyst from the first step can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011282020A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 B1 in paragraphs [0090] to [0094].

Preferably, the catalyst is a tin, titanium, germanium, aluminum or antimony derivative.

By way of example of amounts by weight, use may be made of from 10 to 500 ppm of metal contained in the catalytic system during the stage of condensation of the oligomers, relative to the amount of monomers introduced.

Most preferentially, a catalytic system is used during the first stage and the second stage of polymerization. Said system advantageously consists of a catalyst based on tin or of a mixture of catalysts based on tin, titanium, germanium and aluminum.

By way of example, use may be made of an amount by weight of 10 to 500 ppm of metal contained in the catalytic system, relative to the amount of monomers introduced.

According to the preparation process, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

Finally, the process comprises a step of recovering the polyester at the end of the polymerization step. The thermoplastic polyester thus recovered can subsequently be packaged in an easily handleable form, such as pellets or granules.

According to one variant of the synthesis process, when the thermoplastic polyester is semicrystalline, a step of increasing the molar mass can be carried out after the step of recovering the thermoplastic polyester.

The step of increasing the molar mass is carried out by post-polymerization and may consist of a step of solid-state polycondensation (SSP) of the semicrystalline thermoplastic polyester or of a step of reactive extrusion of the semicrystalline thermoplastic polyester in the presence of at least one chain extender.

Thus, according to a first variant of the production process, the post-polymerization step is carried out by SSP.

SSP is generally carried out at a temperature between the glass transition temperature and the melting point of the polymer. Thus, in order to carry out the SSP, it is necessary for the polymer to be semicrystalline. Preferably, the latter has a heat of fusion of greater than 10 J/g, preferably greater than 20 J/g, the measurement of this heat of fusion consisting in subjecting a sample of this polymer of lower reduced viscosity in solution to a heat treatment at 170° C. for 16 hours, then in evaluating the heat of fusion by DSC by heating the sample at 10 K/min.

Advantageously, the SSP step is carried out at a temperature ranging from 190 to 280° C., preferably ranging from 200 to 250° C., this step imperatively having to be carried out at a temperature below the melting point of the semicrystalline thermoplastic polyester.

The SSP step may be carried out in an inert atmosphere, for example under nitrogen or under argon or under vacuum.

According to a second variant of the production process, the post-polymerization step is carried out by reactive extrusion of the semicrystalline thermoplastic polyester in the presence of at least one chain extender.

The chain extender is a compound comprising two functions capable of reacting, in reactive extrusion, with alcohol, carboxylic acid and/or carboxylic acid ester functions of the semicrystalline thermoplastic polyester. The chain extender may, for example, be chosen from compounds comprising two isocyanate, isocyanurate, lactam, lactone, carbonate, epoxy, oxazoline and imide functions, it being possible for said functions to be identical or different. The chain extension of the thermoplastic polyester may be carried out in all of the reactors capable of mixing a very viscous medium with stirring that is sufficiently dispersive to ensure a good interface between the molten material and the gaseous headspace of the reactor. A reactor that is particularly suitable for this treatment step is extrusion.

The reactive extrusion may be carried out in an extruder of any type, especially a single-screw extruder, a co-rotating twin-screw extruder or a counter-rotating twin-screw extruder. However, it is preferred to carry out this reactive extrusion using a co-rotating extruder.

The reactive extrusion step may be carried out by:
introducing the polymer into the extruder so as to melt said polymer;
then introducing the chain extender into the molten polymer;
then reacting the polymer with the chain extender in the extruder;
then recovering the semicrystalline thermoplastic polyester obtained in the extrusion step.

During the extrusion, the temperature inside the extruder is adjusted so as to be above the melting point of the polymer. The temperature inside the extruder may range from 150 to 320° C.

The semicrystalline thermoplastic polyester obtained after the step of increasing the molar mass is recovered and can subsequently be packaged in an easily handleable form, such as pellets or granules, before being again formed for the requirements of the process for producing the composite material according to the invention.

The second step of the process according to the invention consists in providing natural fibers.

The term “fibers” as used in the present invention is synonymous with the term filaments and yarns and thus includes continuous or discontinuous monofilaments or multifilaments, non-twisted or intermingled multifilaments, base yarns.

The natural fibers may be of plant or animal origin, and are preferably of plant origin. By way of example of natural plant fibers, mention will be made of fibers of cotton, flax, hemp, Manila hemp, banana, jute, ramie, sisal raffia, broom, straw, hay or a mixture thereof. Preferentially, the natural plant fiber used in the process of the invention is a flax fiber.

Plant fibers consist of cellulose, hemicelluloses and lignin, the average contents of which vary depending on the nature of the fibers. For example, cotton does not contain lignin, hemp and flax contain approximately 2-3% and wood contains approximately 26%. The main component of plant fibers, however, is cellulose which is a semicrystalline polymer.

The plant fibers may be in a multitude of forms, for instance in the form of pods, stems, leaves, short fibers, long fibers, particles, wovens or nonwovens. Preferably, for the process of the invention, the fibers are in the form of a nonwoven.

A nonwoven for the purposes of the present invention may be a web, a cloth, a lap, or else a mattress of directionally or randomly distributed fibers, the internal cohesion of which is provided by mechanical, physical or chemical methods or else by a combination of these methods. An example of internal cohesion may be adhesive-bonding, and results in the obtaining of a nonwoven cloth, said nonwoven cloth possibly then being made into the form of a mat of fibers.

The plant fibers have very specific properties such as density or impact strength.

Thus, the density of the fibers used in the process according to the invention may be between 1 and 2 kg/m³, preferably between 1.2 and 1.7 kg/m³ and more preferably between 1.4 and 1.5 kg/m³. The tensile strain at break of the fibers may be between 0.2 and 3 GPa, and preferably between 0.2 and 1 GPa. The fibers are also defined according to their low elongation property. In the process according to the invention, the fibers used advantageously have an elongation (expressed in %) of between 1 and 10%, preferably between 1 and 7%, and more preferably still between 1 and 4%. According to one particular embodiment, the natural fibers used in the process of the invention represent from 25 to 75% by weight relative to the total weight of the composite material, preferentially from 40 to 60% by weight.

Finally, the third step of the process of the invention consists in preparing a composite material from the natural fibers and the thermoplastic polyester as described above.

This preparation step may be carried out by mixing or incorporating the natural fibers into the thermoplastic polyester matrix, said fibers preferably not being dried prior to incorporation into said matrix.

Entirely surprisingly, the incorporation is carried out perfectly despite the absence of a drying step. No aggregation of the fibers is observed and the natural fibers are well dispersed within the matrix, and the fibers do not exhibit any phenomenon of putrefaction.

The incorporation may consist in impregnating the natural fibers with the thermoplastic polyester matrix. The incorporation according to the process of the invention can be carried out by means of techniques known to those skilled in the art, for instance impregnation with a melt or impregnation of the fibers using powders.

After the impregnation, a forming step may be carried out, said forming also being able to be carried out according to the techniques of those skilled in the art, for instance by compression/stamping, by pultrusion, by low pressure under vacuum or else by filament winding.

According to a particular embodiment, the thermoplastic polyester is extruded in sheet form, said extrusion being able for example to be carried out by cast extrusion. Said sheets thus extruded can then be placed on either side of a woven of natural fibers within a press so as to form an assembly consisting of a layer of natural fibers sandwiched between two layers of thermoplastic polyester.

After the action of the press and cooling, the assembly obtained constitutes the composite material, the natural fibers are perfectly incorporated in the thermoplastic polyester and the material forms a particularly strong whole.

By virtue of the very good properties of the thermoplastic polyester, and especially its high fluidity, the natural fibers are correctly impregnated during the incorporation step despite the absence of a drying step. The composite material thus obtained has excellent mechanical properties.

A second subject of the invention relates to a low-density composite material having good impact strength, produced based on natural fibers and thermoplastic polyester as defined previously.

The invention will be understood more clearly by means of the examples and figures below, which are intended to be purely illustrative and do not in any way limit the scope of the protection.

### Examples

### A: Polymerization of a Thermoplastic Polyester

For this example, the thermoplastic polyester is an amorphous polyester. 859 g (6 mol) of 1,4-cyclohexanedimethanol, 871 g (6 mol) of isosorbide, 1800 g (10.8 mol) of terephthalic acid, 1.5 g of Irganox 1010 (antioxidant) and 1.23 g of dibutyltin oxide (catalyst) are added to a 7.5 l reactor. To extract the residual oxygen from the isosorbide crystals, 4 vacuum-nitrogen cycles are carried out once the temperature of the reaction medium is between 60 and 80° C.

The reaction mixture is then heated to 275° C. (4° C./min) under 6.6 bar of pressure and with constant stirring (150 rpm). The degree of esterification is estimated from the amount of distillate collected. The pressure is then reduced to 0.7 mbar over the course of 90 minutes according to a logarithmic gradient and the temperature is brought to 285° C.

These vacuum and temperature conditions were maintained until an increase in torque of 10 Nm relative to the initial torque was obtained. Finally, a polymer rod is cast via the bottom valve of the reactor, cooled in a heat-regulated water bath at 15° C. and chopped up in the form of granules of about 15 mg.

The resin thus obtained has a reduced viscosity in solution of 54.9 ml/g.

The ¹H NMR analysis of the polyester shows that the final polyester contains 44 mol % of isosorbide relative to the diols. With regard to the thermal properties (measured at the second heating), the polymer has a glass transition temperature of 125° C.

### B: Forming of the Amorphous Thermoplastic Polyester by Cast Film Extrusion

The granules obtained in the preceding step are vacuum-dried at 110° C. for 4 h in order to achieve a residual moisture content before the forming of less than 279 ppm.

The granules of thermoplastic polyester obtained in the previous step are extruded in the form of sheets by cast film extrusion.

The cast film extrusion is carried out with a Collin extruder fitted with a flat die, the assembly being completed by a calendering machine.

The granules are extruded in the form of a sheet and the extrusion parameters are collated in table 1 below:

| Parameters | Units | Values |
|---|---|---|
| Temperature (feed −> die) | ° C. | 245/250/260/260/260 |
| Screw rotation speed | Rpm | 80 |
| Temperature of the rollers | ° C. | 40 |

The sheets of thermoplastic polymer thus extruded have a thickness of 1 mm.

### C: Forming of the Composite Material

For this step, a Carver press is used.

A woven of natural flax fibers is placed between two sheets of thermoplastic polymer as previously obtained and the assembly is introduced between the plates of the press before being heated to 180° C.

After a contact of 2 minutes, the temperature of the plates is lowered to 50° C. Once cooled, the plates are separated and the plate of composite material obtained is removed from the press.

The high fluidity of the thermoplastic polyester enables very good impregnation of the natural flax fibers.

Strips are cut from the plates thus obtained. The mechanical properties, including tensile properties, are greatly improved compared to the matrix alone, i.e. the plates of thermoplastic polyester.

1. A process for producing a composite material, comprising the steps of:
a) providing a polymer;
b) providing natural fibers; and
c) preparing a composite material from said natural fibers and said thermoplastic polymer,
wherein that the polymer is a thermoplastic polyester comprising at least one 1,4: 3,6-dianhydrohexitol unit (A), at least one alicyclic diol unit (B) other than the 1,4: 3,6-dianhydrohexitol units (A), at least one terephthalic acid unit (C), wherein the (A)/[(A)+(B)] ratio is at least 0.05 and at most 0.75, said polyester not containing any aliphatic non-cyclic diol units or comprising a molar amount of aliphatic non-cyclic diol units, relative to all the monomer units of the polyester, of less than 5%, and the reduced viscosity in solution (25° C.; phenol (50% m): ortho-dichlorobenzene (50% m); 5 g/l of polyester) of which is greater than 50 ml/g.

2. The process as claimed in claim 1, wherein the alicyclic diol (B) is 1,4-cyclohexanedimethanol, 1,2-cyclohexanedimethanol, or 1,3-cyclohexanedimethanol or a mixture of these diols.

3. The process as claimed in claim 1, wherein 1,4: 3,6-dianhydrohexitol (A) is isosorbide.

4. The process as claimed in claim 1, wherein the natural fibers are not dried prior to the preparation of the composite material.

5. The process as claimed in claim 1, wherein the polyester does not contain any aliphatic non-cyclic diol units, or comprises a molar amount of aliphatic non-cyclic diol units, relative to all the monomer units of the polyester, of less than 1%.

6. The process as claimed in claim 1, wherein the (3,6-dianhydrohexitol unit (A)+alicyclic diol unit (B) other than the 1,4: 3,6-dianhydrohexitol units (A))/(terephthalic acid unit (C)) molar ratio is from 1.05 to 1.5.

7. The process as claimed in claim 1, wherein the natural fibers are fibers of cotton, flax, hemp, Manila hemp, banana, jute, ramie, sisal raffia, broom, straw, or hay or a mixture thereof.

8. The process as claimed in claim 1, wherein the natural fibers are flax fibers.

9. The process as claimed in claim 1, wherein the preparation step is a step of incorporation carried out using a press.

10. The process as claimed in claim 2, wherein the diol is 1,4-cyclohexanedimethanol.

11. The process as claimed in claim 5, wherein the polyester does not contain any aliphatic non-cyclic diol units.
